(19) United States
(12) Patent Application Publication
(10) Pub. No.: US 2022/0316441 A1
(43) Pub. Date: Oct. 6, 2022

(54) OCEAN CURRENT POWER PLANT

(71) Applicant: ArianeGroup GmbH, Taufkirchen (DE)

(72) Inventor: Matthias KAY, Oldendorf (DE)

(21) Appl. No.: 17/708,099

(22) Filed: Mar. 30, 2022

(30) Foreign Application Priority Data
Apr. 1, 2021 (DE) 102021108337.0
Nov. 19, 2021 (DE) 102021130303.6

(51) Int. Cl. F03B 13/26; F03B 13/10

(52) U.S. Cl. CPC F03B 13/264; F03B 13/10; F03B 13/262; F05B 2240/97

(57) ABSTRACT

An ocean current power plant with an electric generator and a turbine, which comprises a stator and a rotor that is rotatable about the stator, for driving the electric generator. The rotor comprises a plurality of rotor arms, which respectively have a carrier mechanism and multiple rotor blades that are pivotably mounted on the carrier mechanism.

### CROSS-REFERENCES TO RELATED APPLICATIONS

This application claims the benefit of the German patent Application No. 102021108337.0, filed on Apr. 1, 2021, and of the German patent Application No. 102021130303.6 filed on Nov. 19, 2021, the entire disclosures of which are incorporated herein by way of reference.

### FIELD OF THE INVENTION

The present invention relates to an ocean current power plant with an electric generator for generating electricity and with a turbine, which comprises a stator and a rotor that is rotatable about the stator, for driving the electric generator.

### BACKGROUND OF THE INVENTION

Various approaches for generating and at the same time reliably providing electricity in the most environmentally acceptable manner possible are currently pursued and associated technologies are (further) developed. In addition to the respective energy made available, for example, by the sun, wind, geothermal heat and rivers, movements of the ocean caused by waves and tides can also be utilized for generating electricity.

Ocean current power plants generate electricity by means of a turbine that is arranged in the natural ocean current. The decisive advantages of such power plants include the fact that ocean currents flow continuously, and a respective ocean current power plant therefore can reliably deliver electricity. The quality of the respective installation site can also be assessed quite well. In comparison with wind power plants, ocean current power plants furthermore require only relatively low flow speeds because the density of water is significantly higher than that of air.

In order to prevent the water from being mixed with air, as well as an associated reduction in the density of the flowing fluid and a drop in productivity, ocean current power plants are frequently installed in such a way that they are completely immersed in the surrounding water; corrosion-related problems are thereby simultaneously reduced.

However, the installation of such power plants is elaborate with respect to hydrotechnical and steel construction aspects because construction work in the open ocean or in river estuaries is demanding and the respective construction materials used have to be compatible for submarine applications and protected against exposure to salt. In addition, the maintenance of such underwater power plants is elaborate due to the difficult accessibility.

Other power plants that convert movements of the ocean into electric energy are at least partially arranged on or above the water surface and designed for not only utilizing the ocean current, but also wave movements.

For example, GB 2 431 437 A discloses a device for generating electric energy from wave movements and ocean currents. The device comprises two propeller-like rotors with horizontally extending rotational axes, as well as a buoyancy element.

In addition, German patent DE 10 2013 019 229 B4 discloses a floating tidal generator for generating electric energy from wave movements and ocean currents.

Further relevant prior art can be found under www.slimlife.eu/wellengenerator.html, as well as in publication US 2004/0 007 881 A1.

### SUMMARY OF THE INVENTION

The present invention is based on an objective of making available a technology for an alternative ocean current power plant, which particularly allows an increased power range and a simplified installation.

An inventive ocean current power plant has an electric generator and a turbine, which comprises a stator and a rotor that is rotatable about the stator.

A central longitudinal axis of the stator preferably forms the rotational axis of the rotor; in an intended operational alignment of the ocean current power plant, the rotational axis of the rotor preferably has a vertical directional component and particularly may extend vertically or at least approximately vertically (e.g., vertically+/−15°). The rotor is designed for driving the electric generator, e.g., by rotating a gearwheel on the drive shaft of the generator that then converts the rotation of the drive shaft into electric energy.

The rotor comprises a plurality of rotor arms, which respectively have a carrier mechanism and multiple rotor blades that are mounted on the carrier mechanism so as to be pivotable (relative thereto).

The rotor arms therefore serve for generating the thrust that causes the rotor to rotate. The plurality of rotor blades allows particularly high energy absorption. Due to their pivotability, the efficiency of the rotor blades particularly can be optimized with a respective alignment, which also allows the use of particularly long rotor arms. An inventive ocean current power plant makes it possible to achieve a particularly high power range and can also be efficiently utilized in areas, in which the ocean current only reaches relatively low speeds. The ocean current power plant has a simple construction with a relatively small number of components and therefore can be very easily installed and proximately maintained.

All rotor arms of an inventive ocean current power plant preferably have the same number of rotor blades, e.g., at least two, at least three or at least four rotor blades and/or no more than six, no more than five or no more than four rotor blades.

It is preferred that at least two or even all rotor arms of an inventive ocean current power plant essentially are designed identically (particularly with respect to their technical aspects).

For example, the carrier mechanism of one, multiple or all rotor arms may form a frame. Such a frame may at least partially encircle one or multiple rotor blades mounted thereon. In order to mount the respective rotor blades, the carrier mechanism may have bearing bushes and/or journals that preferably are designed for being functionally connected to respective journals or bearing bushes on the rotor blades. This allows a particularly simple and solid construction.

The respective pivoting axis (about which the respective rotor blade can be pivoted) for one, multiple or all rotor blades of one, multiple or all rotor arms preferably extends in an inclined manner, particularly orthogonal to the longitudinal extent of the respective rotor aim; the rotor particularly may be designed in such a way that the pivoting axis/axes of one or more rotor blades extend/s vertically when the ocean current power plant is in use.

The rotor arms preferably are designed in such a way that their respective carrier mechanism essentially lies on the water surface (e.g., +/−15 cm or +/−10 cm) horizontally when the ocean current power plant is in use.

According to advantageous exemplary embodiments of the present invention, the rotor of an inventive ocean current power plant comprises four, five, six, seven or eight rotor arms.

One, multiple or all rotor blades of at least one rotor arm preferably has/have an elliptical blade shape, particularly a cross-sectional NACA profile. Rotor blades of this type are advantageous, in particular, with respect to their deflection.

One rotor blade or multiple rotor blades of at least one rotor arm may be at least partially hollow, particularly filled, e.g., with air or another gas. In this case, a ballast weight of the respective rotor blade/rotor blades preferably compensates its/their buoyancy in water when the ocean current power plant is in use. It is particularly preferred that the rotor blades of at least one rotor arm are mounted on the carrier mechanism of the rotor arm in such a way that their buoyancy is counterbalanced.

The pivotability of the rotor blades preferably is limited; starting from an alignment orthogonal to a longitudinal extent of a respective rotor arm (referred to as zero position), for example, a pivoting movement (in both pivoting directions, i.e., toward each side) may be respectively limited, in particular, to no more than 45°, no more than 40° or no more than 30°. This limitation advantageously stabilizes a respective rotor blade position at extreme pivoting angles and the aforementioned angles allow particularly advantageous alignments of the rotor blades for the efficiency of the turbine.

According to advantageous embodiments of an inventive ocean current power plant, one, multiple or each of the rotor arms comprises/comprise a pivoting mechanism that is designed for pivoting multiple or all rotor blades of the respective rotor arm simultaneously. If multiple rotor arms comprise a pivoting mechanism, the respective pivoting mechanisms preferably are designed identically. The pivotability of multiple rotor blades by means of a common pivoting mechanism allows a particularly simple construction of the respective rotor arm.

The respective pivoting mechanism preferably can be designed, in particular, in a purely mechanical manner. For example, it may comprise at least one push rod that engages on the respective rotor blades, particularly on at least one control pin formed thereon.

It is preferred that such a pivoting mechanism can be adjusted in dependence on a respective current rotational position of the respective rotor arm (relative to the stator) such that different pivoting angles are adjusted in at least two different rotational positions of the rotor arm; in this case, the rotational position may be defined, for example, by a respective angle relative to a specified starting position of the rotor arm. In this way, the respective rotor blades particularly can be suitably aligned in terms of the respective direction of the inflowing ocean water. The ocean current power plant preferably comprises at least one pivoting adjustment mechanism that is designed for correspondingly adjusting the pivoting mechanism/s.

In such embodiments, the adjustment of the pivoting mechanism, and therefore of the rotor blades of the associated rotor arm, consequently takes place in accordance with a (mathematical) function, which assigns to each rotational position (as variable) of the respective rotor arm an angle, by which a respective rotor blade belonging to the rotor arm is pivoted with respect to a starting position. This function preferably is continuous. According to advantageous embodiments, the function is 2n-periodic (i.e., cyclic) or periodic with a 360° period such that recurring rotational positions of the rotor aim always entail the same pivoting position.

In embodiments with multiple pivoting mechanisms, these pivoting mechanisms preferably can be adjusted simultaneously by means of a common pivoting adjustment mechanism of this type. In this context, it is preferred that identical rotational positions of the rotor arms lead to identical adjustments of the associated pivoting mechanisms, i.e., a respective pivoting angle of the rotor blades is not dependent on the rotor arm, to which they belong and which is respectively located in a rotational position.

According to advantageous design variations, the at least one pivoting adjustment mechanism is realized in a purely mechanical manner; this allows a particularly simple construction. For example, the at least one pivoting adjustment mechanism may comprise a rail and/or a groove, to which the respective pivoting mechanism is functionally connected, e.g., by engaging therein. In the following description, such a rail is referred to as “control rail” and such a groove is referred to as “control groove”.

It is particularly preferred that such a control rail or control groove extends around the rotational axis of the rotor. In this case, it may have a varying distance from the rotational axis along its circumference, i.e., locations with different distances from the rotational axis. In this way, particularly advantageous angles of the rotor blade surfaces relative to the inflow direction can be realized in dependence on the respective current rotational position in a particularly simple and robust manner.

According to advantageous embodiments, an inventive ocean current power plant comprises an adjustment mechanism that is designed for adapting the rotor to alternating inflow directions occurring during tidal changes. In corresponding embodiments with pivoting adjustment mechanism/s of the above-described type, such an adjustment mechanism particularly may be designed for rotating the pivoting adjustment mechanism/s by 180° about the rotational axis of the rotor every six hours and for locking the pivoting adjustment mechanism/s in the corresponding position. In this way, the ocean current power plant can be optimally adjusted to inflowing water, as well as outflowing water.

The adjustment mechanism may be driven electrically, e.g., by means of an on-board power supply system; to this end, the ocean current power plant may comprise a battery and/or an accumulator for supplying the adjustment mechanism with power. In this way, the adjustment can take place while the generator is not driven during tidal changes.

According to advantageous embodiments of an inventive ocean current power plant, one, multiple or each of the rotor arms is fastened, e.g., suspended, on a central element of the rotor; the central element is also referred to as “rotator” below.

It is preferred that the carrier mechanism of at least one rotor arm points away from the stator with respect to its longitudinal extent.

According to advantageous embodiments, the rotor arms are uniformly arranged around the stator or—in corresponding embodiments—around the rotator, i.e., the rotor arms are equidistantly spaced apart from one another. The rotor particularly may be designed in a star-shaped manner with rotor arms that respectively extend radially outward from the stator or the rotator; in this document, the term “radial” always refers to the rotational axis of the rotor.

It is preferred that at least one of the rotor aims can be pivoted parallel to the rotational axis of the rotor by a (maximum) deflection angle φ.

An associated pivoting axis preferably lies on a radially inner end of the respective rotor arm. In the installed state of the ocean current power plant, in which the rotational axis preferably extends vertically, the rotor arms can be pivoted upward/downward. The pivotability may be limited, e.g., by means of at least one hydraulic damper. It enables the rotor to absorb wave movements. In this way, a capacity utilization of the rotor can be improved and occurring loads can be reduced, wherein embodiments, in which the rotor floats on the water surface, particularly also make it possible to ensure that the rotor arm is at least almost permanently detectable from above the water surface, which in turn contributes to preventing collisions with watercraft.

The following particularly applies to the maximum deflection angle φ:φ≥arcsin(2/A) or φ≥arcsin(3/A) or even φ≥arcsin(5/A); in this case, A is the absolute length of the at least one rotor arm in meters. Such angles respectively make it possible to absorb waves with wave heights of 2 m, 3 m and 5 m.

An ocean current power plant according to such embodiments may comprise at least one wave generator in the form of a hydraulic system, which is designed for being acted upon by respective pivoting movements of the rotor arm/the rotor arms and for thereby converting respective wave energy into electric energy. The performance efficiency of the ocean current power plant can thereby be additionally increased.

An inventive ocean current power plant may comprise one or more buoyancy bodies, which is/are designed for holding one or more element/s of the ocean current power plant on the water surface in a floating manner. In this way, a respective position of the rotor particularly can be automatically adapted to the changing water level occurring with the tides. On the one hand, this makes it possible to always ensure optimal efficiency of the ocean current power plant and the floating arrangement on the other hand allows constant visibility of the ocean current power plant from above the water surface and therefore improved safety with respect to marine traffic. For example, the buoyancy body may be designed for being immersed in the water on the installed ocean current power plant with no more than 80%, no more than 65% or no more than 50% of its volume in the idle position of the rotor. It may be realized, for example, in the form of a hollow body that is at least partially made of shipbuilding steel.

In such embodiments, the stator preferably acts as a guide for the floating rotor, which therefore respectively rises or drops with the changing water level.

The buoyancy body or—if the ocean current power plant comprises multiple buoyancy bodies—at least one of the buoyancy bodies preferably can be designed as part of the rotor, i.e., designed for rotating about the stator. It may be designed, in particular, annularly around the stator. In corresponding embodiments with a rotator (as mentioned above), such a buoyancy body particularly may be fixed on the rotator.

The buoyancy body or at least one such buoyancy body may alternatively or additionally be fixed on a carrier mechanism of one of the (respective) rotor arms and/or on at least one of the rotor blades and, in particular, form a component of the rotor arm. In embodiments, in which at least one of the rotor arms is fastened on a rotator (as a central element) of the rotor so as to be pivotable parallel to the rotational axis of the rotor (as described above), the buoyancy body may cause or at least promote the pivoting movement. In such design variations, the respective buoyancy body preferably is at least partially arranged on a radially outer end of the associated rotor arm. This makes it possible, in particular, to detect this end from above the water level and therefore to ascertain the dimension of the ocean current power plant to its full extent. It is particularly preferred that an individually assigned buoyancy body is fixed on each of the rotor arms.

In particularly advantageous embodiments of an inventive ocean current power plant, at least one buoyancy body is fixed on each rotor arm and on a rotator, on which the rotor arms are fastened. This also ensures the floatability of these components in case their connection to one another separates.

The stator of an inventive ocean current power plant may comprise a mast (that comprises one or multiple parts and preferably is at least partially hollow and/or at least partially solid). Such a mast may be designed rigidly; it may alternatively have one, two or more joints. Such joints advantageously make it possible to absorb a tilting moment that may result from the kinetic energy of the inflow surface acting upon the system, particularly at high watermark.

According to advantageous embodiments, such a mast comprises, at least partially, shipbuilding steel. The stator preferably can have a gearwheel structure in at least one region, preferably on its circumferential surface; in embodiments with an adjustment mechanism (of the above-described type), in particular, the stator can serve as an abutment for at least one gearwheel that preferably belongs to the adjustment mechanism.

The stator preferably comprises a base for being anchored on the ocean floor or on a foundation installed or to be installed on the ocean floor, wherein this foundation may likewise belong to the stator (and comprise, for example, at least partially, reinforced concrete). For example, such a base may be designed in a star-like manner and/or in the form of a flange (e.g., of a mast of the above-described type). If the stator comprises a mast with one or more joints (as mentioned above), one such joint may be mounted on the foundation and/or an (optionally different) joint of this type may be mounted on the side of the central unit facing the foundation.

According to advantageous embodiments, an inventive ocean current power plant comprises at least one sensor device for detecting

a) meteorological data (such as a respective current wind speed, wind direction, air temperature, water temperature, wave height and/or wave direction),

b) ship safety data (e.g., a GPS position, a respective current water level height (corresponding to an inclination of the support arms), location direction (compass), a respective current list angle (corresponding to a lateral inclination) and/or data of a water ingress sensor system),

c) performance data of the electric generator (e.g., a respective current torque per rotor and/or a respective current rotational speed per rotor, a calculated mechanical power per rotor and/or an electrical power per rotor),

d) current data (such as inflow data and/or inflow intensity) and/or

e)—in corresponding embodiments with at least one wave generator of the above-described type—performance data of the wave generator (such as converted power per wave generator, electrical power per wave generator and/or converted power per optionally provided hydraulic damper).

The ocean current power plant preferably comprises control electronics with at least one on-board computer and with at least one transmitter for transmitting data of the on-board computer to at least one onshore receiving station. In corresponding embodiments, the data to be transmitted particularly may comprise, e.g., respectively acquired values of the at least one sensor device, which may likewise belong to the control electronics.

According to advantageous embodiments, an ocean current power plant according to the present invention comprises an electric line with submarine cable connection; a submarine cable to be connected thereto makes it possible to feed the electricity generated by the ocean current power plant to an onshore electrical network. The electric line may be installed along the outside of the stator and/or extend through an interior of the stator; it preferably extends through a/the foundation of the stator.

The stator, particularly, may form part of the central unit of the ocean current power plant, which furthermore comprises an electronics system, as well as—in corresponding embodiments—the aforementioned pivoting adjustment mechanism (for adjusting the pivoting mechanism/s), the aforementioned rotator (on which at least one of the rotor arms may be fastened) and/or the adjustment mechanism (for adapting the ocean current power plant to alternating inflow directions), particularly an adjusting motor, which preferably belongs to the adjustment mechanism, and a separate power supply system with a battery/accumulator for its power supply. In such embodiments, the electronics system includes, for example, the electric generator (preferably with an associated step-up and/or step-down gear); in corresponding embodiments, the electronics system preferably also can at least partially comprise the aforementioned control electronics and/or the aforementioned submarine cable connection.

In such embodiments, the central unit preferably comprises a housing that preferably encloses the electronics system completely. The housing preferably ensures the water tightness of the electronics system.

In this context, the housing preferably is designed for at least partially protruding out of the water surface. In embodiments with one or more buoyancy bodies, at least one such buoyancy body may be arranged in a space enclosed by the housing.

According to advantageous embodiments, the central unit is designed in a floatable manner Consequently, it has its own buoyancy and an intended water line. The intended water line preferably is arranged in such a way that the mechanically rotating parts, particularly the rotator, remain at the same level slightly below the water line.

In corresponding embodiments, it may be rigidly connected, in particular, to the pivoting adjustment mechanism, on which at least one float preferably is fastened. In embodiments with an adjustment mechanism and with an electric line that has a submarine cable connection, the electric line preferably has a cable coil, which is designed for the alternating adjustments by 180°, in the housing.

### BRIEF DESCRIPTION OF THE DRAWINGS

Preferred exemplary embodiments of the invention are described in greater detail below with reference to the drawings. It goes without saying that individual elements and components may also be combined in a different way than in the illustrations. Reference symbols for corresponding elements are used comprehensively in all figures and, if applicable, not described anew for each figure.

In the Schematic Drawings:

FIG. 1 shows an exemplary embodiment of an inventive ocean current power plant in the form of a sectioned side view;

FIG. 2 shows a central unit of an exemplary inventive ocean current power plant viewed from a direction perpendicular to the rotational axis.

FIG. 3 shows a central unit of an exemplary embodiment of an inventive ocean current power plant in the region of the rotor, namely in the form of a section orthogonal to the rotational axis of the rotor;

FIG. 4 shows a rotor arm of an exemplary embodiment of an inventive ocean current power plant with a pivoting mechanism;

FIG. 5 shows a rotor blade of an exemplary inventive ocean current power plant with its rotor blade suspension on a rotor aim;

FIG. 6a shows the rotor of an exemplary inventive ocean current power plant viewed in the direction along the rotational axis;

FIG. 6b shows an illustration of the function of a pivoting adjustment mechanism of an exemplary embodiment of an inventive ocean current power plant; and

FIG. 7 shows part of an exemplary inventive ocean current power plant with wave generator.

### DETAILED DESCRIPTION OF THE PREFERRED EMBODIMENTS

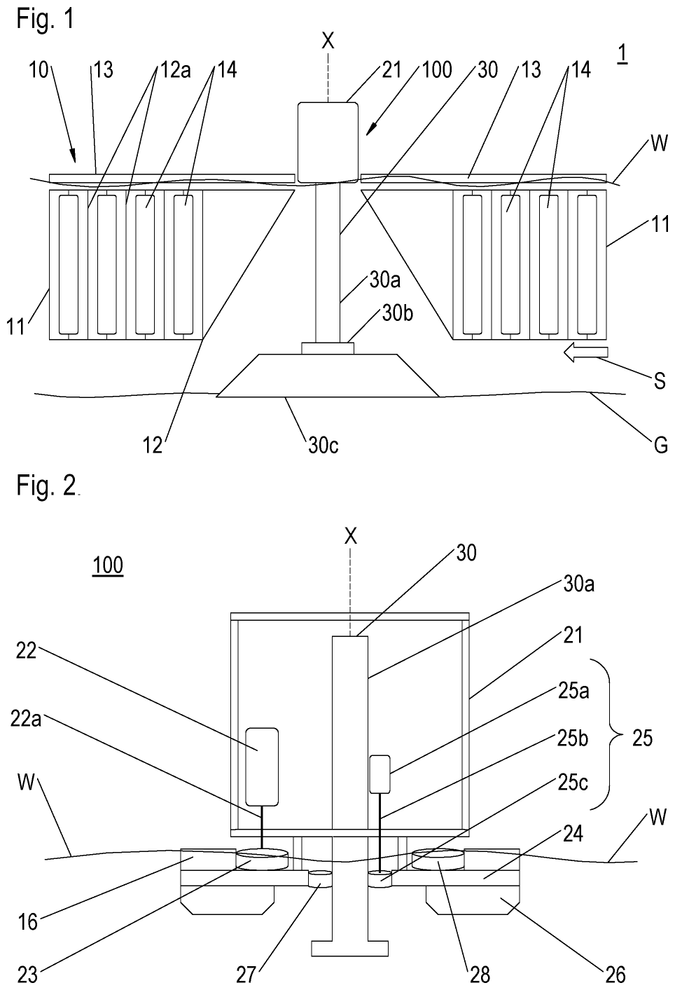

FIG. 1 shows an exemplary embodiment of an inventive ocean current power plant 1 in the form of a sectioned view from a direction extending perpendicular to the rotational axis X, which in the present example is aligned vertically, wherein the ocean current power plant stands on the ocean floor G in an intended operational alignment. In the present example, an inflow direction S extends horizontally and therefore, particularly, perpendicular to the rotational axis X.

The ocean current power plant 1 comprises an electric generator, which in the present example is arranged in a housing 21 of a central unit 100 and not visible in FIG. 1. The ocean current power plant 1 furthermore comprises a turbine with a rotor 10 and an immovable stator 30, which in the present example is realized in the form of a rigid mast 30a with a base 30b in the form of a flange for being anchored on a foundation 30c.

It is preferred that the mast 30a has, at least regionally, a gearwheel structure on its circumferential surface and, therefore, is at least regionally designed in the form of a spline shaft (not visible in the figure).

In an installed ocean current power plant 1, the length of the mast 30a (measured in the direction of the rotational axis X) preferably is adapted to the installation site, particularly to a local water depth at chart datum, a locally occurring tidal range and a predefined safety factor. These parameters also define a required length of the mast 30a in comparison with a height of the housing 21.

A length of the mast 30a, particularly, may amount to at least 7 m, at least 8 m or at least 9 m and/or no more than 15 m, no more than 13 m or no more than 11 m. These lengths advantageously allow the installation at different suitable installation sites. A diameter of the mast 30a orthogonal to the longitudinal axis preferably can amount to at least 30 cm or at least 40 cm and/or no more than 70 cm or no more than 60 cm.

The mast 30a, particularly, may be made of shipbuilding steel. It is preferred that the foundation 30c is at least partially made of reinforced concrete. Its diameter on the ocean floor G preferably lies between 4 m and 8 m, particularly between 5 m and 7 m. A submarine cable connection may be embedded therein.

The rotor 10 of the ocean current power plant 1 comprises multiple rotor arms 11, e.g., four, five, six, seven or eight rotor arms. Two rotor arms 11 are visible in FIG. 1.

In this case, the rotor arms 11 respectively comprise a carrier mechanism 12, which in the present example points away from the stator 30 with respect to its longitudinal extent; in the example shown, its longitudinal extent particularly runs radially (referred to the rotational axis X of the rotor 10). A buoyancy body 13 is respectively fixed on the carrier mechanism 12 and floats on the water surface W when the ocean current power plant 1 is in use, such that the respective rotor arm 10 is held at a constant water depth and, in particular, visible for marine traffic. The respective buoyancy bodies 13 are movably fastened on the central unit 100, e.g., suspended thereon.

In the exemplary embodiment shown, the buoyancy bodies 13 respectively extend over the length of the respective rotor arm 10 up to a radially outer region and thereby indicate a size of the ocean current power plant 1. At least one of the buoyancy bodies 13 may be marked in color for better visibility, for example with a (e.g., yellow) marking. According to advantageous embodiments, at least one of the buoyancy bodies is designed in the form of a closed shipbuilding body. It may be manufactured, for example, from a conical flat oval pipe. It may have at least one fastening flange (that is not illustrated in the figure) for being connected to the carrier mechanism 12.

In the present example, the carrier mechanisms 12 of the rotor arms 11 are respectively designed in the form of a frame, which encircles the multiple (preferably at least three and/or no more than eight or no more than six) rotor blades 14 that likewise belong to the respective rotor arm 11; each rotor arm 11 has four rotor blades 14 in the exemplary embodiment shown.

The respective rotor blades 14 can be pivoted about a respective pivoting axis that extends in the longitudinal direction of the respective rotor blade. The carrier mechanisms 12 of each rotor arm 10 have connecting braces 12a adjacent to each rotor blade 14 in order to stabilize the blade mountings.

The carrier mechanism 12, the buoyancy body 13 and/or the rotor blades 14 preferably are comprised of, at least partially, shipbuilding steel. The mountings for the rotor blades 14 preferably are comprised of, at least partially, special steel.

FIG. 2 shows a central unit 100 of an exemplary inventive ocean current power plant viewed from a direction perpendicular to the rotational axis X, wherein this figure also provides a view into the housing 21 that, particularly, encloses an electric generator 22 of the ocean current power plant. According to advantageous embodiments, the housing has a round (circular) cross section (perpendicular to the rotational axis X). Other preferred elements of an electronics system, e.g., control electronics with an on-board computer, a transmitter for transmitting data and/or at least one sensor device, likewise may (although not shown) be at least partially arranged within the housing 21.

The electric generator 22 converts the rotation of a drive shaft 22a, which is driven by a central element of the rotor in the form of a rotator 16 via a gearwheel 23, into electric energy that preferably can be fed into an electrical network via a not-shown electric line with submarine cable connection and a connected submarine cable. The rotator 16 is set in rotation by rotor arms that are not illustrated in FIG. 2; the rotor arms are fastened, e.g., suspended, on the rotator 16 and in turn moved by a respective ocean current. According to advantageous embodiments of an inventive ocean current power plant, the rotator 16 is thereby driven with a rotational speed of 50% to 90%, preferably 60% to 80%, of an inflow speed of 1 m/sec to 2 m/sec.

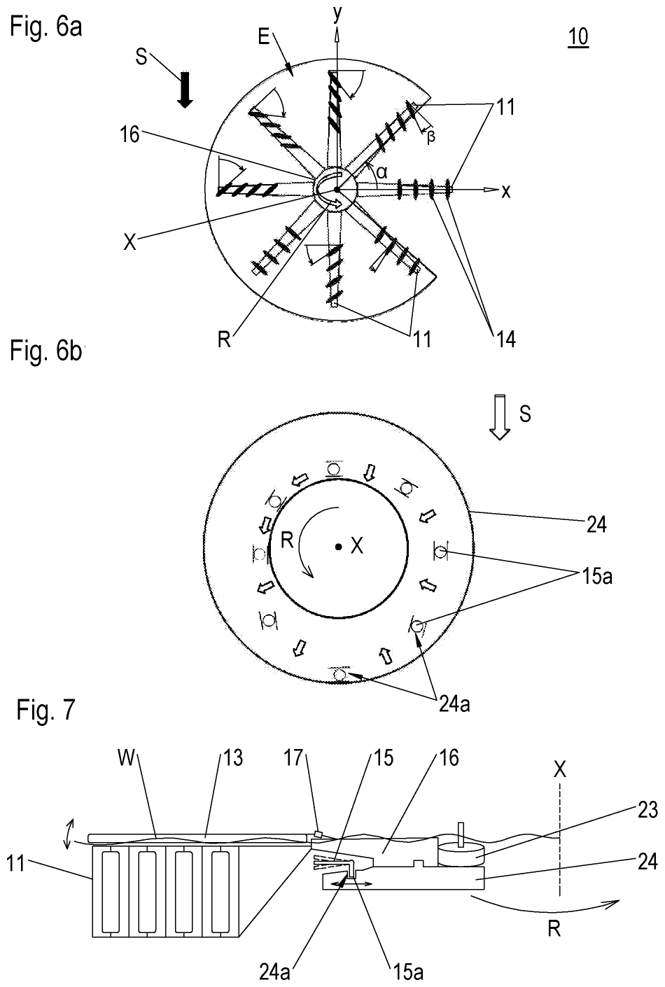

The central unit 100 furthermore comprises a pivoting adjustment mechanism 24 (which in the present example is realized in the form of a control disk) for adjusting respective pivoting mechanisms of the rotor arms in dependence on their respective current rotational position, wherein this is described in greater detail below, in particular, with reference to FIGS. 6a, 6b. In this case, the rotator 16 is rotatable relative to the pivoting adjustment mechanism 24 (about the rotational axis X). In the intended operational alignment of the ocean current power plant (or its central unit 100) shown in the figure, the pivoting adjustment mechanism 24 is arranged underneath the rotator 16.

The housing 21 likewise encloses an adjusting motor 25a of an adjustment mechanism 25, which in the present example also comprises a shaft 25b and a gearwheel 25c and is designed for adjusting, i.e., correspondingly adapting, the ocean current power plant to alternating inflow directions occurring with tidal changes. To this end, the gearwheel 25c, which is set in rotation by the adjusting motor 25a via the shaft 25b, engages into a gear structure in the (radially) inner surface of the pivoting adjustment mechanism 24, wherein a gear structure on a radially outer surface of the mast 30a of the stator 30 serves as abutment. In this way, the pivoting adjustment mechanism 24 is rotated about the stator 30, preferably by 180°, together with the rotator 16 fixed thereon. The position of the pivoting adjustment mechanism 24 (that is not designed rotationally symmetrical) relative to the flow direction, which reverses with the tidal change, influences the pivoting positions of the respective rotor blades on the rotor arms as described in greater detail below, in particular, with reference to FIGS. 6a, 6b.

Another gearwheel 27 is in idle mode and merely serves for stabilizing the pivoting adjustment mechanism 24. A gearwheel 28 similarly is in idle mode and merely serves for stabilizing the rotator 16.

In the present example, the central unit 100 furthermore comprises an annular buoyancy body 26, on which the pivoting adjustment mechanism 24 is fastened, wherein this buoyancy body is designed for holding the pivoting adjustment mechanism on a water surface W in a floating manner. A (not-shown) buoyancy body may be arranged in the space enclosed by the housing 21 alternatively or additionally to the annular buoyancy body 26.

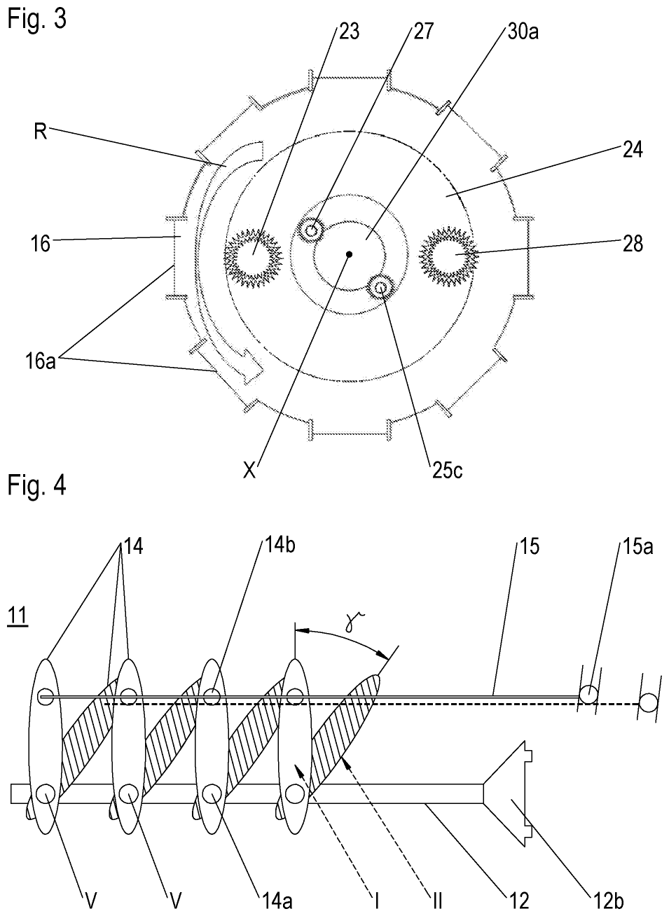

FIG. 3 shows the annular rotator 16 from the direction of the housing 21 (which is not illustrated in FIG. 2) together with the subjacent pivoting adjustment mechanism 24, the mast 30a of the stator 30, the gearwheel 23 connected to the drive shaft of the electric generator, the gearwheel 25c of the adjustment mechanism 25 and the additional gearwheels 27 and 28. In the present example, the rotator 16 has on its outer circumference eight stops 16a for anchoring (e.g., by means of bolts) not-shown rotor arms, by means of which it is set in rotation about the rotational axis X in the rotating direction R as a result of an ocean current. Buoyancy bodies on the rotor arms, as well as the buoyancy body 26 illustrated in FIG. 2, are designed for holding the rotator 16 on a water surface, particularly at water line.

The rotator 16 has on its edge surface facing the rotational axis X a (not-shown) gear structure in the form of a gear ring, which engages into the gearwheel 23 and thereby drives the (not-shown) electric generator via its drive shaft.

The pivoting adjustment mechanism 24 in the form of a disk likewise has a (not-shown) gear structure in the form of a gear ring on its edge surface facing the rotational axis X. The gearwheel 25c of the adjustment mechanism 25 engages into this gear structure and furthermore into a gear structure on the outer surface of the mast 30a. When the gearwheel 25c is set in rotation by the adjusting motor 25a (see FIG. 2), the pivoting adjustment mechanism 24 is respectively rotated about the mast 30a or the rotational axis X (preferably together with the housing 21 and at least some of the components arranged therein). In this way, the ocean current power plant can be adapted to the alternating inflow directions occurring with tidal changes. The adjustment mechanism 25 furthermore serves for locking the pivoting adjustment mechanism 24 while the adjusting motor is at a standstill during the operation of the ocean current power plant.

According to advantageous embodiments, the rotator 16 comprises a forged steel ring. During the operation of the ocean current power plant, it is preferably held on the water surface in a floating manner by buoyancy bodies 13 of the rotor arms 11, e.g., buoyancy bodies of the type illustrated in FIG. 1.

FIG. 4 schematically shows a rotor arm 11 with a carrier mechanism 12, which in the present example has a thickened suspension 12b for being connected to a (not-shown) rotator by means of two bolts. In the exemplary embodiment shown, four rotor blades 14 are respectively mounted on the carrier mechanism 12 so as to be pivotable about an associated pivoting axis V; in this case, respective journals 14a of the rotor blades 14 respectively engage into a (not-shown) bearing bush in the form of a recess in the carrier mechanism 12.

In this case, the pivoting movement can be accomplished simultaneously for all rotor blades 14 of the rotor arm 11 by means of a pivoting mechanism 15, which in the present example is realized in the form of a push rod and engages on a respective control pin 14b of each rotor blade 14. The rotor blades 14 of the rotor arm 11 can be simultaneously pivoted about their respective pivoting axis V by displacing the push rod in the direction of its longitudinal axis as indicated with broken lines in FIG. 4. A maximum pivoting angle γ preferably is limited; the rotor blades can be pivoted by +/−45°, preferably by no more than +/−40° or +/−30°, relative to a position I, in which they lie transverse to a longitudinal extent of the rotor aim (unhatched in FIG. 4). In FIG. 4, a position II after a maximum pivoting movement by the pivoting angle γ of presently 30° is indicated with hatched rotor blades.

The operation of the pivoting mechanism 15 preferably is realized by means of a control head 15a on its end facing the (not-shown) rotator, wherein the control head engages into a rail or groove that acts as pivoting adjustment mechanism; this is described in greater detail further below with reference to FIG. 6b.

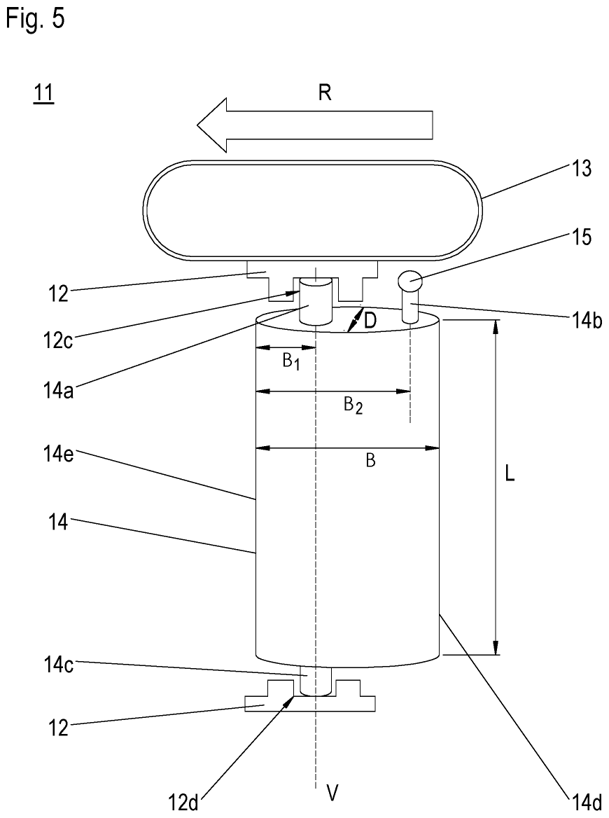

FIG. 5 shows a rotor arm 11 of an exemplary inventive ocean current power plant in the form of a section along a rotating direction R of the rotor arm 11 (i.e., perpendicular to its longitudinal alignment). In this case, the rotor arm 11 is illustrated in an intended operational alignment, in which the buoyancy body 13 is fastened on top of the carrier mechanism 12 and the rotor blades, particularly the rotor blade 14 shown, preferably extend vertically referred to their longitudinal alignment.

FIG. 5 particularly shows a rotor blade suspension of the rotor blade 14 on the carrier mechanism 12: journals 14a, 14c on opposite ends of the rotor blade 14 respectively engage into a bearing bush 12c, 12d of the carrier mechanism 12. The bearings consisting of journals 14a, 14c and bearing bushes 12c, 12d preferably run without any lubricant other than water.

A pivoting mechanism 15, which in the present example is realized in the form of a push rod extending perpendicular to the plane of projection of FIG. 5, engages on a control pin 14b on the upper end of the rotor blade 14 and can thereby cause the above-described pivoting movement about the pivoting axis V.

In the present example, the rotor blade 14 has an advantageous blade shape with a NACA profile. It particularly has an elliptical cross section (perpendicular to the longitudinal alignment). Its blade surfaces preferably are designed in the form of surfaces of a hollow, welded shipbuilding construction that is provided with ribs, wherein the journals 14a, 14c preferably are welded to the ends of this construction.

The blade surfaces have a length L and a width B that is defined by the distance of an inflow edge 14d from an outflow edge 14e of the rotor blade 14. The rotor blade furthermore has a (maximum) thickness D that is measured in the direction perpendicular to the length L and the width B. In this case, the blade width B preferably is chosen in dependence on a respective length of the associated rotor arm just like the number of rotor blades and the maximum pivoting angle γ; the length of the rotor aim may amount, for example, to at least 8 m, at least 10 m or at least 12 m and/or no more than 16 m or no more than 13 m.

In these examples, the width B of the rotor blades 14 may lie, for example, between 1 m and 3 m, particularly in the range between 1.5 m and 2.5 m, and/or the thickness D may lie in the range between 20 cm and 60 cm, particularly in the range between 30 cm and 50 cm.

The length L of the blade surfaces (and therefore the immersion depth) preferably is adapted to a usable water depth (at low tide) in the (intended) installation position; for example, it may be 1 m to 2 m smaller than this water depth. The installation of the ocean current power plant 1 in many suitable installation positions can be advantageously realized with embodiments, in which the length L lies in the range between 6 m and 10 m, particularly in the range between 7 m and 9 m.

The journals 14a, 14c are spaced apart from the outflow edge 14e by a distance B1, wherein 0.2B≤B1≤0.3B preferably applies. The control pin 14b is spaced apart from the outflow edge 14e by a distance B2, wherein it is alternatively or additionally preferred that 0.6B≤B2≤0.9B or even 0.7B≤B2≤0.8B applies.

FIG. 6a shows the rotor 10 of an inventive ocean current power plant viewed in the direction along the rotational axis X; the drawing therefore corresponds to a top view of the installed ocean current power plant. It shows that the rotor 10 has in the present example eight rotor arms 11 that are fastened on the rotator 16 and respectively provided with four rotor blades 14, wherein the rotor has in a counterclockwise rotating direction R an effective area E in the form of a sector of approximately 270°. The illustration in FIG. 6a shows the rotor in a coordinate system, in which the effective area E lies axially symmetrical to the x-axis.

The rotor blades 14 can be pivoted into a respective alignment that depends on a respective current rotational position of the respective rotor arm 11 by means of the pivoting mechanisms of the rotor arms 11, which are not illustrated in FIG. 6a, and a pivoting adjustment mechanism, which is likewise not illustrated in FIG. 6a. The respective rotational position in FIG. 6a is defined by the angle α between the respective rotor aim 11 and the x-axis; however, the angle is in this figure only indicated for one of the rotor arms 11 in order to provide a better overview. In this case, the y-axis extends in the inflow direction S and its values increase opposite to the inflow direction S. The angle α=0 particularly lies in the rotational position 0, in which only counterpressure has to be overcome, and the angle α=90° lies in the rotational position facing the inflow direction.

Respective angles θ (of which only one is indicated in FIG. 6a) show a pivoting movement of the rotor blades toward the inside (i.e., toward the rotational axis X) or toward the outside (away from the rotational axis X) starting from an alignment tangential to the rotating direction. In the present example, the values of β are advantageously adjusted in dependence on the rotational position and therefore in dependence on the angle α as shown in the following table:

| α | β | |
|---|---|---|
| 0° | 0° | |
| 45° | 15° | inward |
| 90° | 30° | inward |
| 135° | 30° | inward |
| 180° | 30° | inward |
| 225° | 0° | |
| 270° | 30° | outward |
| 315° | 15° | outward |

| | |
|---|---|
| 360° = 0 | 0° |

FIG. 6b elucidates how a pivoting adjustment mechanism 24, which in the present example is realized in the form of a control disk, can correspondingly adjust the pivoting mechanisms 15 of the rotor arms in dependence on a respective current rotational position of the respective rotor arm:

To this end, the pivoting adjustment mechanism 24 has a control groove 24a with a rotationally asymmetrical extent around the rotational axis X, of which only the sections belonging to the positions of the rotor arms illustrated in FIG. 6a are shown in FIG. 6b, wherein a control head 15a on the end of a pivoting mechanism 15 in the form of a push rod engages into the control groove. When the rotor is rotated by means of the pivoting adjustment mechanism 24, the control heads 15a are guided about the rotational axis X along the control groove 24a and in the process assume different distances from the rotational axis X. In the present example, this causes the respective different pivoting movements of the rotor blades in accordance with the table shown above. The directional tendency is indicated with arrows in FIG. 6b.

FIG. 7 shows a rotor arm 11 that is suspended on the rotator 16. A control head 15a is arranged on the end of a pivoting mechanism 15, which in the present example is designed in the form of a push rod and only partially and schematically illustrated in order to provide a better overview, wherein the control head engages into the control groove 24a of the pivoting adjustment mechanism 24. A double arrow in FIG. 7 indicates that a rotation of the rotator 16 about the rotational axis X changes its distance from the control head 15a and thereby causes a respective adjustment of the pivoting mechanism 15 in dependence on a respective current rotational position of the respective rotor arm 11, which in turn implies a respective pivoting movement of the rotor blades 14.

In the exemplary embodiment shown, the rotor arm 11 can be pivoted by a deflection angle parallel to the rotational axis X (in the present example upward and downward) as indicated with another double arrow in FIG. 7. Such pivoting movements are caused by wave movements and the buoyancy body 13. The pivoting mechanism 15 therefore can also be pivoted accordingly as schematically indicated with positions drawn with broken lines in FIG. 7. The pivoting mechanism 15 has a joint in the exemplary embodiment shown; this joint, particularly, may be designed in the form of a universal joint. It is preferred that the pivoting mechanism 15 alternatively or additionally lies in one plane with the carrier mechanism 12.

In the present example, the pivotability of the rotor aim is limited by means of a hydraulic system 17 comprising a hydraulic damper, e.g., respectively limited to no more than 20° or no more than 15° in both directions (upward and downward). The hydraulic system 17 is acted upon by respective pivoting movement of the rotor arm 11 and can thereby convert occurring movements of the ocean into electric energy.

The invention discloses an ocean current power plant 1 with an electric generator 22 and a turbine, which comprises a stator 30 and a rotor 10 that is rotatable about the stator, for driving the electric generator 22. The rotor comprises a plurality of rotor arms 11, which respectively have a carrier mechanism 12 and multiple rotor blades 14 that are pivotably mounted on the carrier mechanism.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SYMBOLS

1 Ocean current power plant
10 Rotor
11 Rotor arm
12 Carrier mechanism
12a Connecting brace
12b Suspension
12c, 12d Bearing bush
13 Buoyancy body
14 Rotor blade
14a, 14c Journal
14b Control pin
14d Inflow edge
14e Outflow edge
15 Pivoting mechanism
15a Control head
16 Central element/rotator
16a Stop
17 Hydraulic system
21 Housing
22 Electric generator
22a Drive shaft
23 Gearwheel
24 Pivoting adjustment mechanism
25 Adjustment mechanism
25a Adjusting motor
25b Shaft
25c Gearwheel
26 Buoyancy body
27, 28 Gearwheel
30 Stator
30a Mast
30b Base
30c Foundation
100 Central unit
B Rotor blade width
B₁ Distance of journals from outflow edge
B₂ Distance of control pin from outflow edge
D Rotor blade thickness
E Effective area
G Ocean floor
L Rotor blade length
R Rotating direction
S Inflow direction
V Pivoting axis
W Water surface
X Rotational axis

1. A current power plant for use in a current of an ocean, comprising
an electric generator, and
a turbine, which comprises a stator and a rotor that is rotatable about the stator, for driving the electric generator,
wherein the rotor comprises a plurality of rotor arms, which respectively have a carrier mechanism and multiple rotor blades that are pivotably mounted on the carrier mechanism.

2. The ocean current power plant according to claim 1, wherein one, multiple or each of the rotor arms comprises a pivoting mechanism that is configured to pivot multiple or all rotor blades of a respective rotor arm simultaneously.

3. The ocean current power plant according to claim 2, wherein the ocean current power plant furthermore comprises a pivoting adjustment mechanism that is configured to adjust the pivoting mechanisms in dependence on a respective current rotational position of the respective rotor arm.

4. The ocean current power plant according to claim 1, which furthermore comprises an adjusting mechanism that is configured to adapt the ocean current power plant to alternating inflow directions occurring with tidal changes.

5. The ocean current power plant according to claim 1, wherein one, multiple or each of the rotor arms is fastened on a central element of the rotor so as to be pivotable parallel to a rotational axis of the rotor.

6. The ocean current power plant according to claim 5, which furthermore comprises a wave generator formed as a hydraulic system that is configured to be acted upon by respective pivoting movements of at least one rotor arm and for thereby converting respective wave energy into electric energy.

7. The ocean current power plant according to claim 1, which comprises one or more buoyancy bodies configured to hold one or more elements of the ocean current power plant on a water surface in a floating manner.

8. The ocean current power plant according to claim 7, wherein at least one buoyancy body is fixed on the carrier mechanism of one of the respective rotor arms.

9. The ocean current power plant according to claim 1, wherein the stator is rigid.

10. The ocean current power plant according to claim 1, wherein the stator comprises a mast with a base for being anchored on a floor of the ocean or on a foundation.
